(19) United States
(12) Patent Application Publication
(10) Pub. No.: US 2009/0095944 A1
(43) Pub. Date: Apr. 16, 2009

(54) LIFTING APPARATUS

(76) Inventor: Robert G. Gaines, Brighton, MI (US)

Correspondence Address: CARGILL & ASSOCIATES, P.L.L.C., 56 MACOMB PLACE, MT. CLEMENS, MI, 48043, US

(21) Appl. No.: 12/239,340

(22) Filed: Sep. 26, 2008

Related U.S. Application Data
(60) Provisional application No. 60/975,369, filed on Sep. 26, 2007.

(51) Int. Cl. B66D 3/04

(52) U.S. Cl. 254/334

(57) ABSTRACT

A lifting apparatus for extending upwardly out of a commercial building roof hatch, including a ladder docking device surrounding the roof hatch and optionally including roof hatch grab bars for ease of emergence through the roof hatch. The roof hatch ladder docking device is rapidly and removably attached to a permanent vertical ladder attached to the interior of the building. The lifting apparatus includes a winch post, a pulley mounted on the winch post and the ladder attachment device includes a fixed lower ladder attachment bracket along with a sliding upper ladder attachment sleeved over the winch post.

### TECHNICAL FIELD

This invention relates generally to lifting apparatuses and more particularly to rooftop applications and roof hatch applications for lifting loads once a worker is atop a roof.

### BACKGROUND OF THE INVENTION

Conventional workers that need to perform maintenance and construction on rooftops are always needing to have equipment lifted to the rooftop once the worker has climbed up a ladder to get on the roof. Needless to say, it is important to have a lifting system to bring items that are weighty to the rooftop without having to lift the equipment and pieces manually.

Safety, which is of growing importance these days, is to be extended to rooftop construction workers and maintenance workers by providing a simple and effective means for lifting things up to the roof while providing a safe method for the workers to do the lifting. Heretofore, lifting systems have been cumbersome, difficult to install, and unsafe. Various aspects of the present invention provide methods for quick installation in roof hatches and on roof edges, as well as various throws of the winch arm, depending upon an end sheave or return sheave being utilized.

Other aspects of the present invention will become clear when the entire detailed description of the invention has been reviewed.

### SUMMARY OF THE INVENTION

A lifting apparatus is disclosed for coming up out of a roof hatch. The lifting apparatus has a ladder docking device surrounding the roof hatch, and may optionally include roof hatch grab bars for ease of emergence through the roof hatch up the permanently attached vertical steel ladder to which the winch post is pivotally and removably mounted. A load, which can be lifted by winch arm, which places the load in a position that can be pivoted up through the roof hatch and then twirled on pivoting post to place load on top of roof, ready for installation and maintenance work, whatever is required.

For roof edge applications, a longer throw arm with an end sheave is useful for dropping a cable downwardly and over the edge of the roof. A winch post is removably attached to the roof edge, with any desirable attachment means to the parapet. One of ordinary skill in the art can determine the appropriate securement for his particular application, depending upon the configuration of the roof edge. Conventional commercial buildings have flat roofs with parapets at the edge to which the lifting apparatus can be attached. Since the winch post is removable and pivots, the load can be lifted up from the ground to above roof parapet height and then pivoted around to release the load on the roof, for further work.

For extremely easy installation, the present invention discloses a pivoting winch post including a post component and having a fixed lower ladder attachment bracket along with a sliding upper ladder attachment bracket and a lifting hook. The post component is easily, quickly and removably attached to the already installed permanent vertical steel ladder, and then the winch component lifting apparatus can be installed thereon. It takes less than one minute to install the winch post and the lifting apparatus, making it a fast and effective way of lifting items to make the job easier.

### BRIEF DESCRIPTION OF THE DRAWINGS

FIG. 1 illustrates a perspective view of a lifting apparatus made in accordance with the present invention coming up out of a roof hatch;

FIG. 2 is a side elevational view of a lifting apparatus made in accordance with the present invention for roof edge applications, showing a longer throw arm with a end sheave;

FIG. 3 shows a side perspective view of the lifting apparatus 10 on a roof and illustrates the use of a shortened return cable throw facilitated by return sheave bracket;

FIG. 4 shows the opposite side of the lifting apparatus to show the relative placement of return sheave bracket;

FIG. 5 shows the load of FIG. 1 as it is coming up through roof hatch by a cable;

FIG. 6 is a side perspective view of the pivoting winch post;

FIG. 7 is a schematic drawing of winch post of FIG. 6;

FIG. 8 shows a fixed lower ladder attachment bracket, including the terminal end of the winch post;

FIG. 9 illustrates a sliding upper ladder attachment bracket generally denoted, including a ladder rung support bracket;

FIG. 10 illustrates a sliding upper ladder attachment bracket shown being put into place, within a conventional roof hatch and attaching to a permanent vertical steel ladder;

FIG. 11 shows the sliding upper ladder attachment bracket in place around the permanent vertical steel ladder; and

FIG. 12 illustrates a view of a fixed lower ladder attachment bracket where the winch post is held in position.

### DETAILED DESCRIPTION OF THE INVENTION

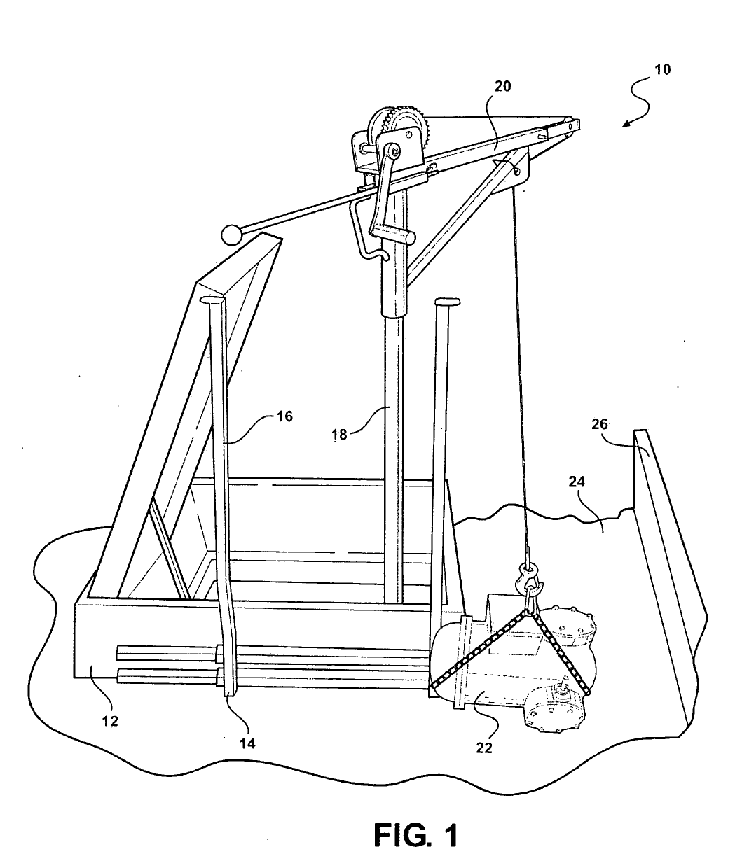

FIG. 1 illustrates a lifting apparatus generally denoted by numeral 10 in situ coming up out of a roof hatch 12 having a ladder docking device 14 surrounding roof hatch 12. Ladder docking device 14 may optionally include roof hatch grab bars 16 for ease of emergence through the roof hatch up the permanently attached vertical steel ladder (not shown in this Figure, although shown hereinafter in FIG. 5 et seq.), to which the winch post 18 is pivotally and removably mounted. A load 22, which is an air compressor motor, is shown being lifted by winch arm 20 which places load 22 in a position that can be pivoted up through the roof hatch and then twirled on pivoting post 18 to place load 22 on top of roof 24, ready for installation and maintenance work, whatever is required.

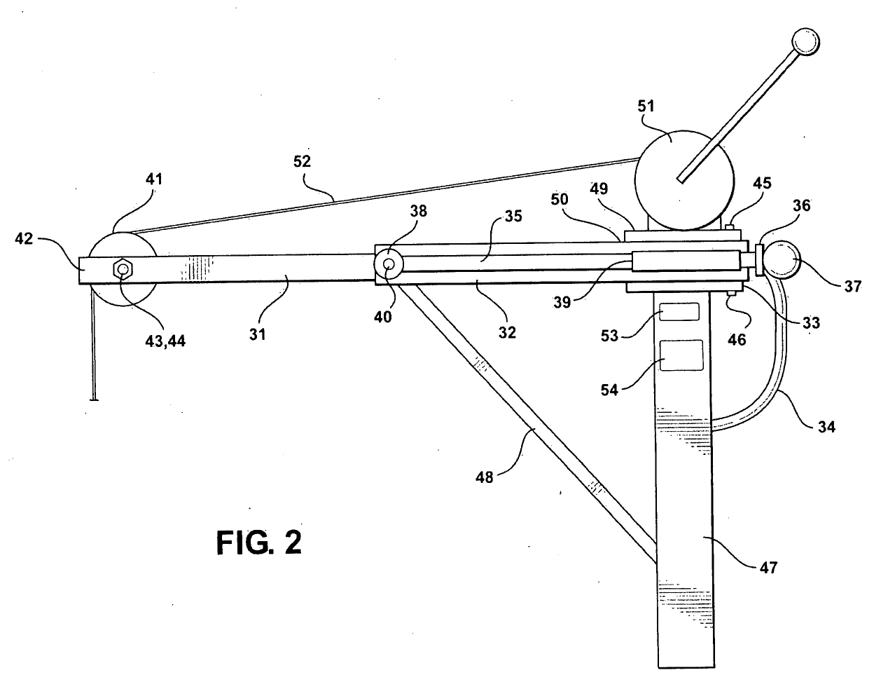

Looking next to FIG. 2, a lifting apparatus made in accordance with the present invention for roof edge applications, showing a longer throw arm 31 with a end sheave 41 dropping a cable 52 downwardly and over the edge of the roof. The winch post 47 is removably attached to the roof edge, with any desirable attachment means to the parapet 26 as shown in FIG. 1. One of ordinary skill in the art can determine the appropriate securement for his particular application, depending upon the configuration of the roof edge. Conventional commercial buildings have flat roofs with parapets at the edge to which the lifting apparatus 10 can be attached. Since the winch post 47 is removable and pivots, the load can be lifted up from the ground to above roof parapet height and then pivoted around to release the load on the roof, for further work.

Looking back again at FIG. 2, a side elevational view of the winch system of the present invention is shown in which the winch arm 31 is a small square tube, which may be optionally telescoped into a larger square tube arm portion 32. Base plate bottom 33 is fixedly mounted to winch post 47 and may include a turning handle tube 39 affixed thereon. A turning handle washer 38 may be utilized. At the distal end of arm portion 32, a hitch pin 40 may be threadedly or inserted through turning handle washer 38, such that the arm 31 may be retracted for transportation. Distal sheave 41 may be attached to extension arm end 42 by extension arm bolt 43 and secured with extension arm nut 44. In order to attach winch 51 to front support block 49, base bolt 45 is utilized to secure the winch 51 and its base to the arm 31. Winch 51 retracts and extends cable 52 in order to lift the loads. Attached to winch post 47 is a maximum load label 53 and a metal identification tag 54.

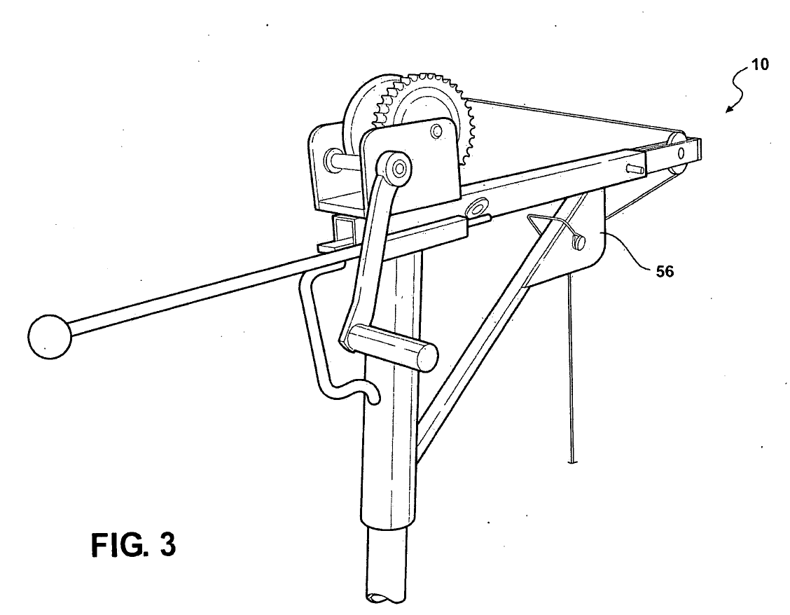

FIG. 3 shows a side perspective view of the lifting apparatus 10 on a roof and illustrates the use of a shortened return cable throw facilitated by return sheave bracket 56.

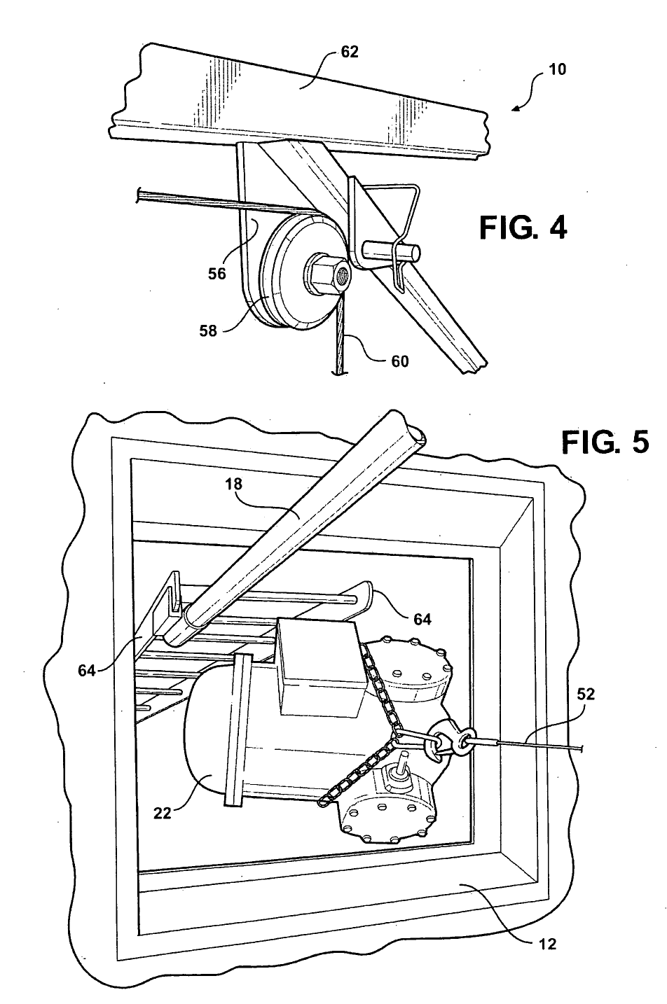

FIG. 4 shows the opposite side of the lifting apparatus 10 to show the relative placement of return sheave bracket 56 with a return sheave 58 bolted thereto for relocating the cable sixties position to make this applicable to a roof hatch application, rather than a roof edge application.

FIG. 5 shows the load 22 of FIG. 1 as it is coming up through roof hatch 12 by cable 52. Winch post 18 is shown removably attached to the permanent vertical steel ladder 64 which is conventional and required for buildings having flat roofs and roof hatches. As one can see, load 22 is lifted from up within the building next to the permanent vertical steel ladder 64 until it clears the roof hatch curb 12, at which point the winch may be pivoted on pivot post 18 to release load 22 onto roof 24 (as shown in FIG. 1).

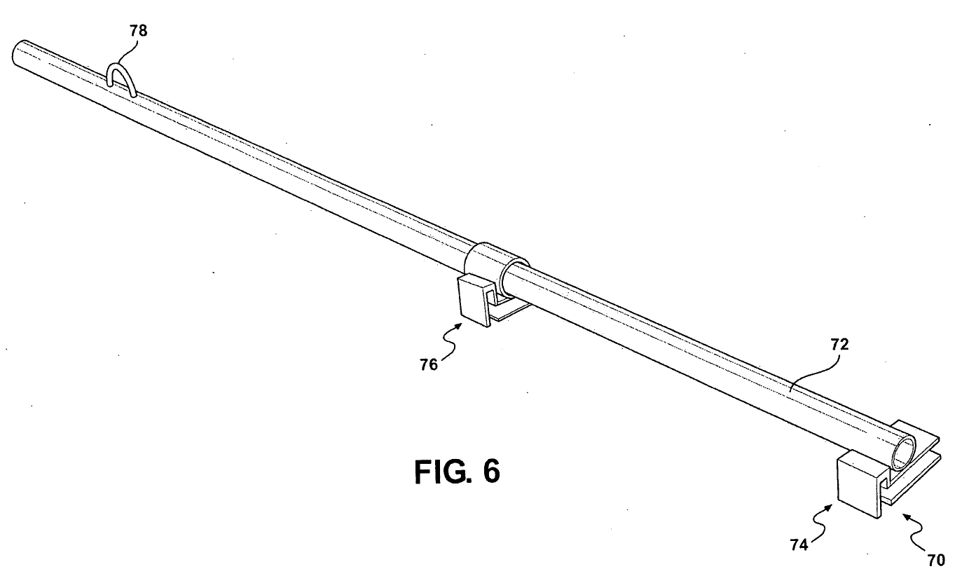

FIG. 6 is a side perspective view of the pivoting winch post generally denoted by numeral 70. Winch post 70 includes a post component 72 and having a fixed lower ladder attachment bracket 74 along with a sliding upper ladder attachment bracket 76 and a lifting hook 78.

The post component 72 is easily, quickly and removably attached to the already installed permanent vertical steel ladder, and then the winch component lifting apparatus 10 is installed thereon. It takes less than one minute to install the winch post and the lifting apparatus, making it a fast and effective way of lifting items to make the job easier.

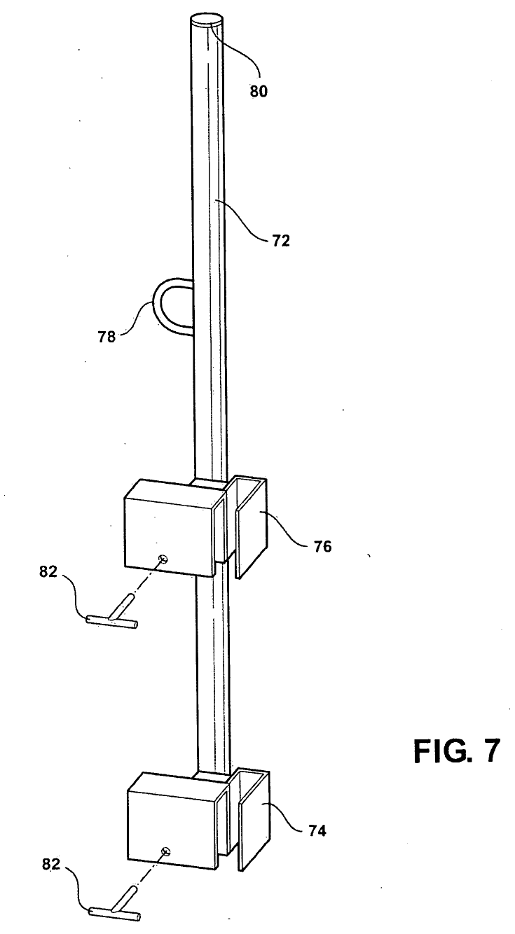

FIG. 7 is a schematic drawing of winch post 70 of FIG. 6, in which the element numbers are the same including a winch post 72 and showing in schematic form the fixed lower attachment bracket 74, and sliding upper attachment bracket 76. Lifting hook 78 can be any location that is appropriate for the application and most likely will include a cap 80. Once the winch post 72 is in position and laid into the permanent vertical steel ladder that is already installed in the building, a safety pin 82 may be utilized to secure the sliding upper attachment bracket 76 in place and the fixed lower attachment bracket 74.

Looking now to FIG. 8, there is shown a fixed lower ladder attachment bracket generally denoted by numeral 74, including the terminal end of winch post 72 and having attached thereto, by a feasible means, including, but not limited to welding, bolting, brazing, soldering, gluing, etc. A ladder rung support bracket 90 and a ladder upright support bracket 92.

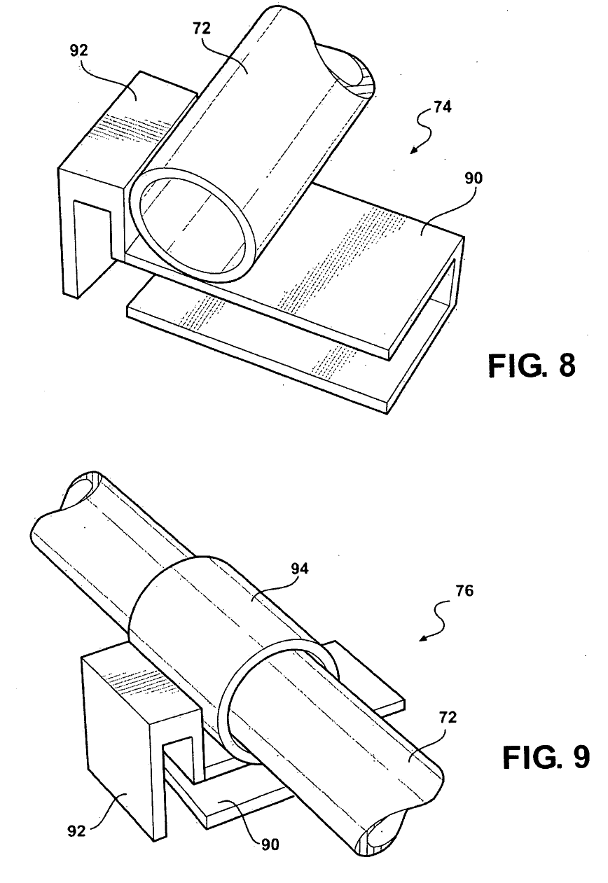

Likewise, FIG. 9 illustrates a sliding upper ladder attachment bracket generally denoted by the numeral 76, including a ladder rung support bracket 90 and ladder upright support bracket 92 permanently affixed to a post slide 90. Sliding upper ladder attachment bracket 76 is clearly infinitely adjustable, and will accommodate any variable ladder rung distance from the fixed ladder adjustment bracket shown in FIG. 8. In other words, the fixed ladder adjustment bracket 74 shown in FIG. 8 is placed onto a permanent ladder rung, and the sliding upper ladder adjustment bracket 76 can be attached to the uppermost ladder rung coming out of roof hatch 12.

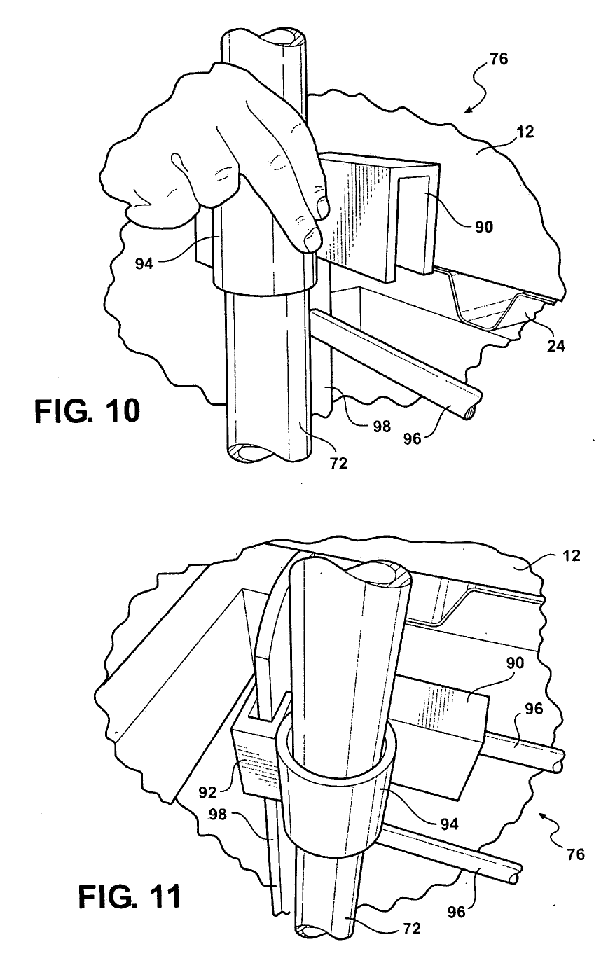

Looking now to FIG. 10, sliding upper ladder attachment bracket 76 is shown being put into place, within roof hatch 12 and attaching to a permanent vertical steel ladder which is permanently attached to the building. The permanent vertical steel ladder attached to the building includes permanently attached ladder rungs 96 and uprights 98. This conventional ladder extends from an area within the building up through the roof hatch 12. The sliding upper ladder adjustment bracket 76 includes post slide 94 and ladder rung support bracket 90. In FIG. 10, the sliding support bracket 90 for ladder rungs is shown hovering above the ladder rung before it is slid into place before it is slid into place on top of ladder rung 96. Post slide 94 is slideably attached to the winch post 72 and cannot be released off either end because it is prevented by sliding off the bottom by the fixed bracket and is prevented from sliding off the top by the lifting hook.

FIG. 11 shows the sliding upper ladder attachment bracket 76 in place around the permanent vertical steel ladder and in position relative to ladder rungs 96 and ladder uprights 98. Winch post 72 extends upward and through roof hatch 12 and is secured in place by ladder rung support bracket 90 and ladder upright support bracket 92.

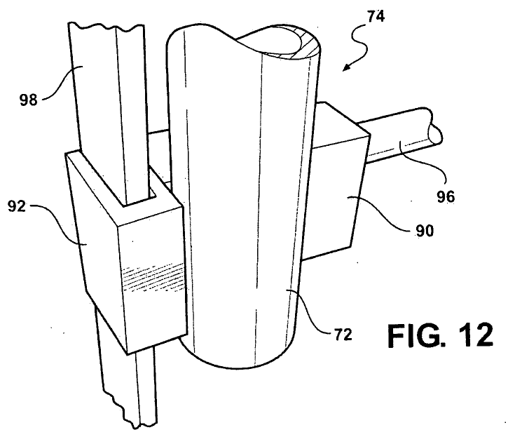

Lastly, we look at FIG. 12 to view a fixed lower ladder attachment bracket generally denoted by numeral 74 where the winch post 72 is held in position against ladder rung 96 and ladder upright 98 by ladder rung support bracket 90 and ladder upright support bracket 92.

Although the invention has been described by way of examples hereinabove for specific embodiments having certain features, it must also be realized that minor modifications that do not require undo experimentation on the part of the practitioner are covered within the scope and breadth of this invention. Additional advantages and other novel features of the present invention will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention.

1. A lifting apparatus for rapidly attaching to a permanent vertical ladder emerging up from the interior of a building through a roof hatch, comprising:
a winch post;
a pulley mounted on the winch post;
a fixed lower ladder attachment bracket permanently attached to the winch post; and
a sliding upper ladder attachment sleeved over the winch post, so that the sliding upper ladder attachment can be pulled out while the lower ladder attachment is positioned on a rung of the permanent vertical ladder emerging up from the interior of the building and then allowing the sliding upper ladder attachment to fall down and be secured on a rung of the ladder that is above the lower ladder attachment bracket.
